(19) United States
(12) Patent Application Publication
(10) Pub. No.: US 2011/0228854 A1
(43) Pub. Date: Sep. 22, 2011

(54) APPARATUS AND METHOD FOR ENCODING/DECODING A VIDEO SIGNAL

(75) Inventors: Il-Hong Shin, Daejeon (KR); Jung-Won Kang, Daejeon (KR); Jeong-Ju Yoo, Daejeon (KR); Jin-Woo Hong, Daejeon (KR)

(73) Assignee: Electronics and Telecommunications Research Institute, Daejeon (KR)

(21) Appl. No.: 13/130,905

(22) PCT Filed: Aug. 17, 2009
(86) PCT No.: PCT/KR2009/004576

§ 371 Date: May 24, 2011

(30) Foreign Application Priority Data
Nov. 24, 2008 (KR) 10-2008-0116931

(51) Int. Cl. H04N 7/26

(52) U.S. Cl. 375/240.16; 375/E07.125

(57) ABSTRACT

Provided is an apparatus and method for encoding and decoding a video signal. A video signal encoding apparatus may include: a reference image storage unit to store a reference image; a template motion estimation unit to estimate a motion between an input image and the reference image using a template, and to generate motion estimation information; an adaptive motion compensation unit to generate a predicted image using the motion estimation information and the reference image, to calculate a filter coefficient with respect to the predicted image using the template, and to filter the predicted image using the filter coefficient; a transformation and quantization unit to perform integer-transformation and quantization for a differential image that is a difference between the input image and the filtered predicted image; and an entropy encoding unit to entropy encode the quantized differential image and to output an image stream.

### TECHNICAL FIELD

The present invention relates to an apparatus and method for encoding and decoding a video signal, and more particularly, to an apparatus and method for encoding and decoding a video signal that may estimate a motion using a template and may perform an adaptive motion compensation using the template, when decoding or encoding a video signal.

### BACKGROUND ART

H.264 indicates a video compression standard that may provide a significantly high compression rate in comparison to MPEG-4 or H.263+ corresponding to a previous video compression standard. H.264 is also referred to as H.264/advanced video coding (AVC). Currently, various types of paid or free services are being provided using H.264/AVC. The free services may include, for example, a digital multimedia broadcasting (DMB) service. The paid services may include communication provider services, for example, June of SKT and Fimm of KTF, and a satellite DMB service.

Also, various types of H.264/AVC codec based services may be provided to users. H.264 may provide video data of a high quality corresponding to a DVD level at a speed less than 1 Mbps. Accordingly, in the case of a high-speed Internet access through a radio, a satellite, or an asymmetric digital subscriber line (ADSL), H.264 may provide perfect motion picture video data of 30 frames per second (fps).

Also, when a current MPEG-2 based broadcasting system is also changed to H.264/AVC-based broadcasting system, it is possible to provide a broadcasting service with a further enhanced high definition, for example, about twice greater than MPEG-2, using a bandwidth 19.39 Mbps that is currently used by a current high definition broadcasting service. When increasing a number of channels, the number of channels may increase by about twice greater than the current number of channels.

In H.264, a block including 16×16 pixels indicates a single macro block. The macro block may be divided into various sizes of blocks. In order to more accurately perform a motion prediction and compensation, a macro block mode may be determined using an intra prediction in a pixel area, various types of block sizes, a multi-reference screen, and a ratio-distortion optimization scheme. Through this, in comparison to an existing motion picture compression standard, it is possible to save bits of about 50% with respect to the same screen quality.

Although H.264 is a highly effective video coding scheme, there is an increasing need for a new video codec with a further enhanced compression ratio. Accordingly, the Joint Video Team (JVT) is on manufacturing key technology area (KTA) reference software and verifying a new idea.

In H.264, a filter coefficient for ½ or ¼ pixel motion compensation is fixed. However, in order to enhance a performance of the H.264 codec, a non-separable adaptive interpolation filtering scheme is currently applied. The non-separable adaptive interpolation filtering scheme may obtain an adaptive filter coefficient according to a pixel 1, ½, or ¼ of a motion vector that is selected in a current image and a motion-compensated image generated after estimating a motion. The non-separable adaptive interpolation filtering scheme may transmit the adaptive filter coefficient to a decoding unit. The decoding unit may perform a motion compensation calculation and filtering according to the filter coefficient and then generate a reference image frame. Currently, a transmission may be performed by assuming a 6×6 two-dimensional (2D) filter with respect to a single frame screen. The above scheme generally considers the entire single frame as a target. Therefore, when the above scheme is applied to a significantly variable image, the efficiency may be small.

### DISCLOSURE OF INVENTION

### Technical Problem

An aspect of the present invention provides an apparatus and method for encoding and decoding a video signal.

Another aspect of the present invention also provides an apparatus and method for encoding and decoding a video signal that may estimate a motion using a template and may adaptively compensate for the motion using the template, when decoding or encoding a video signal.

Another aspect of the present invention also provides an apparatus and method for encoding and decoding a video signal that may estimate a motion using a template, calculate a motion compensation filter coefficient using the template, filter a predicted image using the filter coefficient, and perform an adaptive motion compensation, when encoding or decoding a video signal.

### Solution to Problem

According to an aspect of the present invention, there is provided an apparatus for encoding a video signal, the apparatus including: a reference image storage unit to store a reference image; a template motion estimation unit to estimate a motion between an input image and the reference image using a template, and to generate motion estimation information; an adaptive motion compensation unit to generate a predicted image using the motion estimation information and the reference image, to calculate a filter coefficient with respect to the predicted image using the template, and to filter the predicted image using the filter coefficient; a transformation and quantization unit to perform integer-transformation and quantization for a differential image that is a difference between the input image and the filtered predicted image; and an entropy encoding unit to entropy encode the quantized differential image and to output an image stream.

According to another aspect of the present invention, there is provided an apparatus for decoding a video signal, the apparatus including: an entropy decoding unit to entropy decode an input image stream; an inverse-transformation and inverse-quantization unit to perform inverse-quantization and inverse-transformation for the decoded input image stream and to recover a differential image; a de-blocking filter to de-blocking filter an image where a predicted image and the differential image are added, and to generate an output image; a reference image storage unit to store the output image as a reference image for the predicted image; a template motion estimation unit to estimate a motion between recent reference images using a template, and to generate motion estimation information; and an adaptive motion compensation unit to generate a subsequent predicted image using the motion estimation information and the reference image, to calculate a filter coefficient, and to filter the subsequent predicted image using the filter coefficient.

According to still another aspect of the present invention, there is provided a method of encoding a video signal, the method including: verifying a template and estimating a motion of the template using an input image to be encoded and a reference image to generate motion estimation information, when the input image is received; generating a predicted image using the motion estimation information and the reference image; calculating a filter coefficient with respect to the predicted image using the template; filtering the predicted image using the filter coefficient; calculating a difference between the input image and the filtered predicted image to generate a differential image; performing integer-transformation and quantization for the differential image; and entropy encoding the quantized differential image to output an image stream.

According to yet another aspect of the present invention, there is provided a method of decoding a video signal, the method including: entropy decoding an input image stream, when the input image stream is received; performing inverse-quantization and inverse-transformation for the decoded input image stream to recover a differential image; de-blocking filtering an image where a predicted image and the differential image are added, to generate an output image; storing the output image as a reference image; verifying a template and estimating a motion of the template using recent reference images to generate motion estimation information; generating a subsequent predicted image using the motion estimation information and the reference image; calculating a filter coefficient with respect to the subsequent predicted image using the template; and filtering the subsequent predicted image using the filter coefficient.

### Advantageous Effects of Invention

According to embodiments of the present invention, there is provided an apparatus and method for encoding and decoding a video signal that may estimate a motion using a template, calculate a motion compensation filter coefficient using the template, perform filtering using the filter coefficient, and perform an adaptive motion compensation, when encoding or decoding a video signal. Since the motion is estimated using the template, there is no need to transmit a motion vector. Also, the adaptive motion compensation may be performed using the calculated filter coefficient.

### BRIEF DESCRIPTION OF DRAWINGS

FIG. 1 is a block diagram illustrating a configuration of an encoding apparatus according to an embodiment of the present invention;

FIG. 2 is a diagram illustrating a configuration of a template with respect to a current macro block in an encoding and decoding apparatus according to an embodiment of the present invention;

FIG. 3 is a block diagram illustrating a configuration of an adaptive motion compensation unit in an encoding and decoding apparatus according to an embodiment of the present invention;

FIG. 4 is a block diagram illustrating a configuration of a decoding apparatus according to an embodiment of the present invention;

FIG. 5 is a flowchart illustrating a method of encoding an image in an encoding apparatus according to an embodiment of the present invention; and

FIG. 6 is a flowchart illustrating a method of decoding an image stream in a decoding apparatus according to an embodiment of the present invention.

### MODE FOR THE INVENTION

Reference will now be made in detail to embodiments of the present invention, examples of which are illustrated in the accompanying drawings, wherein like reference numerals refer to the like elements throughout. The embodiments are described below in order to explain the present invention by referring to the figures. When it is determined detailed description related to a related known function or configuration they may make the purpose of the present invention unnecessarily ambiguous in describing the present invention, the detailed description will be omitted here.

Provided is an apparatus and method for encoding and decoding a video signal that may estimate a motion using a template, calculate a motion compensation filter coefficient using the template, perform filtering using the filter coefficient, and perform an adaptive motion compensation, when encoding or decoding a video signal.

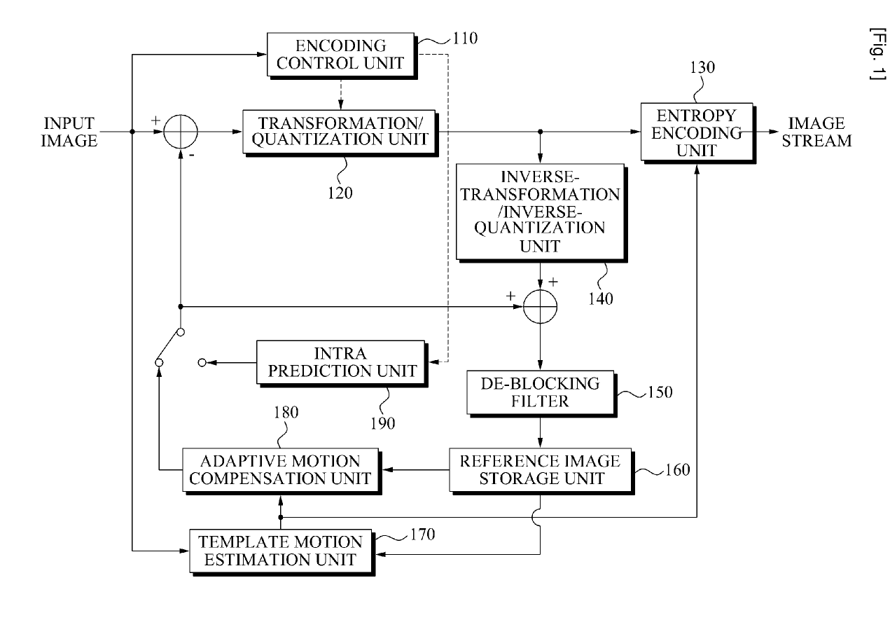

FIG. 1 is a block diagram illustrating a configuration of an encoding apparatus according to an embodiment of the present invention.

Referring to FIG. 1, the encoding apparatus may include an encoding control unit 110, a transformation and quantization unit 120, an entropy encoding unit 130, an inverse-transformation and inverse-quantization unit 140, a de-blocking filter 150, a reference image storage unit 160, a template motion estimation unit 170, an adaptive motion compensation unit 180, and an intra prediction unit 190.

When an input image is processed as an intra frame, a prediction process may be performed for the input image by the intra prediction unit 190 via the encoding control unit 110. Next, a predicted image signal may be transformed and be quantized by the transformation and quantization unit 120 and be output via the entropy encoding unit 130. Also, the image signal may be stored in the reference image storage unit 160 via the inverse-transformation and inverse-quantization unit 140 and the de-blocking unit 150, and be used for a prediction process of a subsequent frame.

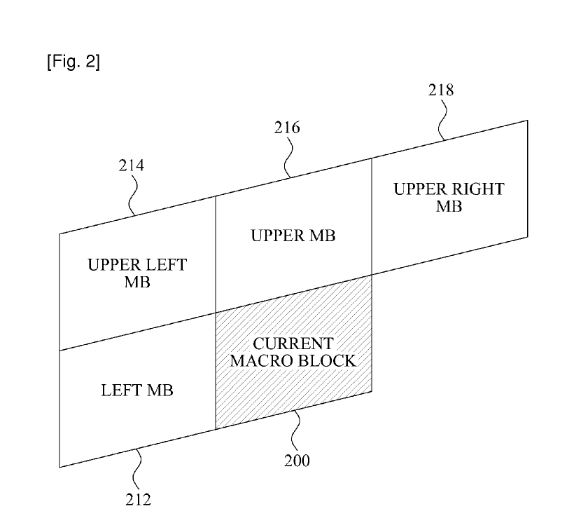

According to an embodiment of the present invention, when the input image is processed as an inter frame, the template motion estimation unit 170 may verify a template, estimate a motion between the input image and a reference image stored in the reference image storage unit 160, using the template, and provide motion estimation information using the template to the adaptive motion compensation unit 180. Here, the motion estimation information using the template denotes information associated with the estimated motion of the image by searching for the reference image in a most similar region to a template region that is pre-set in the input image. Hereinafter, the template will be described with reference to FIG. 2.

FIG. 2 is a diagram illustrating a configuration of a template with respect to a current macro block 200 in an encoding and decoding apparatus according to an embodiment of the present invention.

The encoding and decoding apparatus may include a left macro block 212, an upper-left macro block 214, an upper macro block 216, and an upper-right macro block 218 based on the current macro block 200.

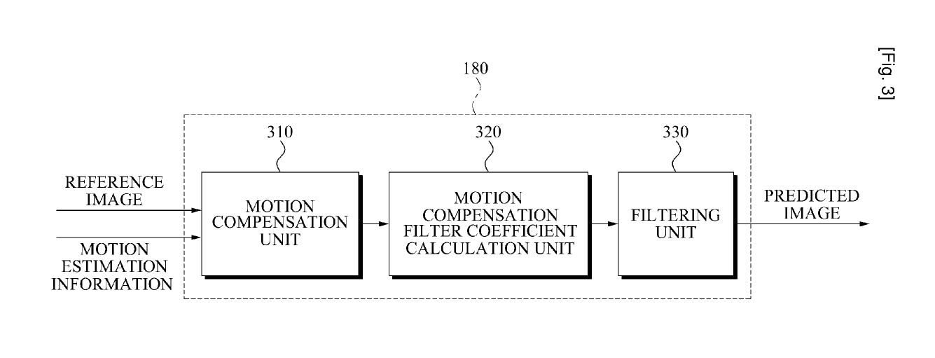

The adaptive motion compensation unit 180 may generate a predicted image using motion estimation information and a reference image stored in the reference image storage unit 160, calculate a filter coefficient with respect to the predicated image using a template, and filter the predicted image using the filter coefficient. Hereinafter, the adaptive motion compensation unit 180 will be described in detail with reference to FIG. 3.

FIG. 3 is a block diagram illustrating a configuration of the adaptive motion compensation unit 180 in an encoding and decoding apparatus according to an embodiment of the present invention. Referring to FIG. 3, the adaptive motion compensation unit 180 may include a motion compensation unit 310, a motion compensation filter coefficient calculation unit 320, and a filtering unit 330.

The motion compensation unit 310 may generate a predicted image using motion estimation information and a reference image stored in the reference image storage unit 160 of FIG. 1, and may provide the predicted mage to the motion compensation filter coefficient calculation unit 320.

The motion compensation filter coefficient calculation unit 320 may calculate a filter coefficient with respect to the predicted image, using a template based on a current macro block. The calculation scheme may include, for example, a least square estimation scheme as given by the following Equation 1:

$$arg {min}_{H} {\sum }_{i = \{ left , upperleft , current , upper , upperright \}} {\vert B - {T}_{i} \cdot H \vert}^{2} . \qquad [ Equation 1 ]$$

Here, B indicates a current macro block as a matrix, H indicates a convolution kernel of a filter as the matrix, and T, denotes a macro block of a reference image corresponding to a macro block of an input image.

The motion compensation filter coefficient may be calculated by obtaining H that may minimize the above Equation 1. The filtering unit 330 may filter the predicted image using the calculated motion compensation filter coefficient.

Referring again to FIG. 1, the transformation and quantization unit 120 may receive a differential image that is a difference between the input image and the filtered predicted image, perform an integer-transformation and quantization for the differential image, and provide the quantized differential image to the entropy encoding unit 130 and the inverse-transformation and inverse-quantization unit 140. The entropy encoding unit 130 may entropy encode the quantized differential image to output an image stream.

The inverse-transformation and inverse-quantization unit 140 may recover the differential image by performing inverse-transformation and inverse-quantization for the quantized differential image. The reference image storage unit 160 may store the reference image that is generated by adding the differential image and the input image.

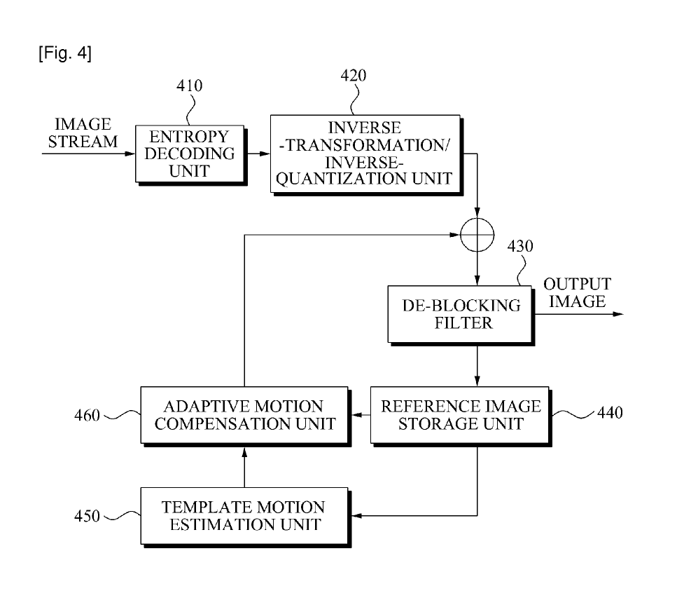

FIG. 4 is a block diagram illustrating a configuration of a decoding apparatus according to an embodiment of the present invention. Referring to FIG. 4, the decoding apparatus may include an entropy decoding unit 410, an inverse-transformation and inverse-quantization unit 420, a de-blocking filter 430, a reference image storage unit 440, a template motion estimation unit 450, and an adaptive motion compensation unit 460.

The entropy decoding unit 410 may entropy decode an input image stream. The inverse-transformation and inverse-quantization unit 420 may perform inverse-quantization and inverse-transformation for the decoded input image stream to recover a differential image.

The de-blocking filter 430 denotes a filter that may smooth a boundary error of a block occurring in block-based coding. The de-blocking unit 430 may de-blocking filter an image where a predicted image and the differential image are added and may generate an output image.

The reference image storage unit 440 may store the output image as a reference image for a subsequent predicted image.

The template motion estimation unit 450 may verify a template, estimate a motion between recent reference images stored in the reference image storage unit 440, using the template, and provide motion estimation information using the template to the adaptive motion compensation unit 460.

The adaptive motion compensation unit 460 may generate the predicted image using motion estimation information and a reference image stored in the reference image storage unit 440, calculate a filter coefficient with respect to the predicted image using the template, and filter the predicted image using the filter coefficient. A detailed configuration of the adaptive motion compensation unit 460 will be the same as the configuration of FIG. 3 and thus further detailed description related thereto will be omitted here.

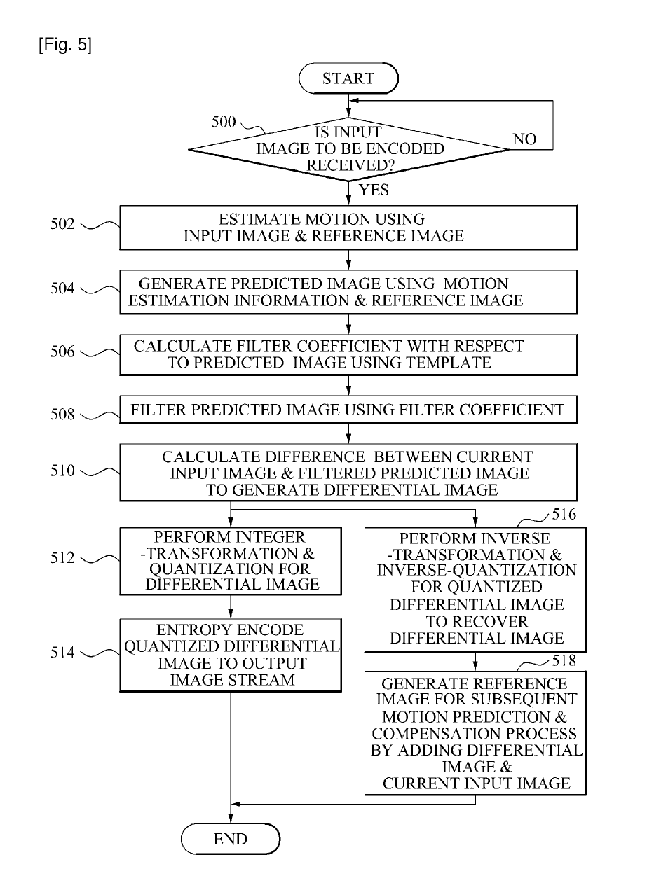

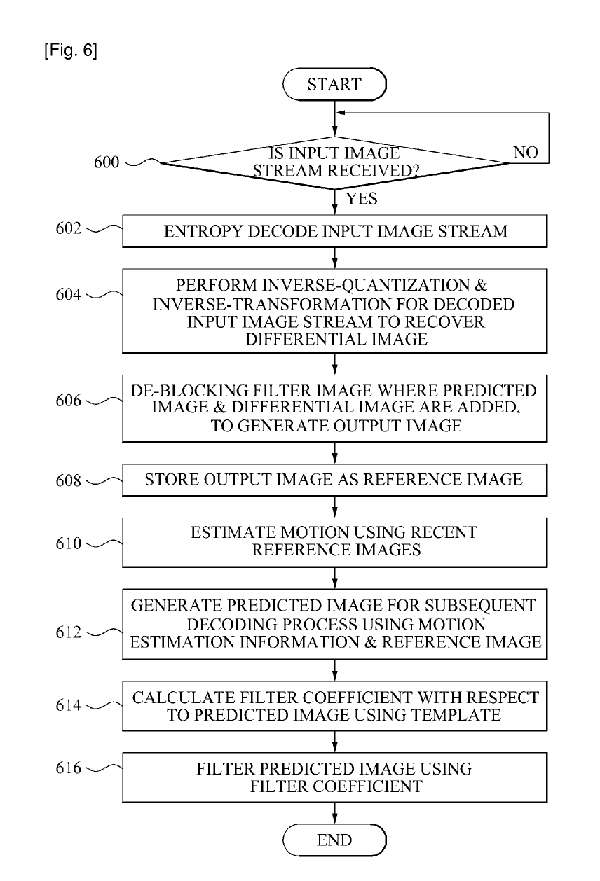

Hereinafter, a method of encoding and decoding a video signal according to an embodiment of the present invention will be described with reference to FIGS. 5 and 6.

FIG. 5 is a flowchart illustrating a method of encoding an image in an encoding apparatus according to an embodiment of the present invention.

Referring to FIG. 5, when an input image to be encoded is received in operation 500, the encoding apparatus may verify a template and estimate a motion of the template using the input image and a reference image in operation 502. In operation 504, the encoding apparatus may generate a predicted image using motion estimation information using the template and the reference image. In operation 506, the encoding apparatus may calculate a filter coefficient with respect to the predicted image using the template. In operation 508, the encoding apparatus may filter the predicted image using the filter coefficient.

In operation 510, the encoding apparatus may calculate a difference between a current input image and the filtered predicted image to generate a differential image. In operation 512, the encoding apparatus may perform integer-transformation and quantization for the differential image. In operation 514, the encoding apparatus may entropy encode the quantized differential image to output an image stream.

Also, for an encoding process of a subsequent input image after operation 510, the encoding apparatus may perform inverse-transformation and inverse-quantization for the quantized differential image to recover the differential image in operation 516. In operation 518, the encoding apparatus may generate a reference image for a subsequent motion prediction and compensation by adding the differential image and the current input image and may store the generated reference image.

FIG. 6 is a flowchart illustrating a method of decoding an image stream in a decoding apparatus according to an embodiment of the present invention.

Referring to FIG. 6, when an input image stream is received in operation 600, the decoding apparatus may entropy decode the input image stream in operation 602. In operation 604, the decoding apparatus may perform inverse-quantization and inverse-transformation for the decoded input image stream to recover a differential image. In operation 606, the decoding apparatus may de-blocking filter an image where a predicted image and the differential image are added, to generate an output image and may output the output image.

In operation 608, the decoding apparatus may store the output image as a reference image. In operation 610, the decoding apparatus may verify a template and estimate a motion using the template based on recent reference images.

In operation 612, the decoding apparatus may generate a predicted image for a subsequent decoding process using the motion estimation information using the template and the reference image. In operation 614, the decoding apparatus may calculate a filtering coefficient with respect to the predicted image using the template. In operation 616, the decoding apparatus may filter the predicted image using the filter coefficient.

The exemplary embodiments of the present invention include computer-readable media including program instructions to implement various operations embodied by a computer. The media may also include, alone or in combination with the program instructions, data files, data structures, tables, and the like. The described hardware devices may be configured to act as one or more software modules in order to perform the operations of the above-described embodiments of the present invention, or vice versa.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

1. An apparatus for encoding a video signal, the apparatus comprising:
a reference image storage unit to store a reference image;
a template motion estimation unit to estimate a motion between an input image and the reference image using a template, and to generate motion estimation information;
an adaptive motion compensation unit to generate a predicted image using the motion estimation information and the reference image, to calculate a filter coefficient with respect to the predicted image using the template, and to filter the predicted image using the filter coefficient;
a transformation and quantization unit to perform integer-trans-formation and quantization for a differential image that is a difference between the input image and the filtered predicted image; and
an entropy encoding unit to entropy encode the quantized differential image and to output an image stream.

2. The apparatus of claim 1, wherein the template is a macro block that is located in any one of an upper side, a left side, an upper-left side, and an upper-right side of a current macro block.

3. The apparatus of claim 1, wherein the adaptive motion compensation unit comprises:
a motion compensation unit to generate the predicted image using the motion estimation information and the reference image;
a motion compensation filter coefficient calculation unit to calculate the filter coefficient with respect to the predicted image using the template; and
a filtering unit to filter the predicted image using the filter coefficient.

4. The apparatus of claim 3, wherein the motion compensation filter coefficient calculation unit calculates the filter coefficient using a least square estimation scheme.

5. An apparatus for decoding a video signal, the apparatus comprising:
an entropy decoding unit to entropy decode an input image stream;
an inverse-transformation and inverse-quantization unit to perform inverse-quantization and inverse-transformation for the decoded input image stream and to recover a differential image;
a de-blocking filter to de-blocking filter an image where a predicted image and the differential image are added, and to generate an output image;
a reference image storage unit to store the output image as a reference image for the predicted image;
a template motion estimation unit to estimate a motion between recent reference images using a template, and to generate motion estimation information; and
an adaptive motion compensation unit to generate a subsequent predicted image using the motion estimation information and the reference image, to calculate a filter coefficient, and to filter the subsequent predicted image using the filter coefficient.

6. The apparatus of claim 5, wherein the template is a macro block that is located in any one of an upper side, a left side, an upper-left side, and an upper-right side of a current macro block.

7. The apparatus of claim 5, wherein the adaptive motion compensation unit comprises:
a motion compensation unit to generate the subsequent predicted image using the motion estimation information and the reference image;
a motion compensation filter coefficient calculation unit to calculate the filter coefficient with respect to the subsequent predicted image using the template; and
a filtering unit to filter the subsequent predicted image using the filter coefficient.

8. The apparatus of claim 7, wherein the motion compensation filter coefficient calculation unit calculates the filter coefficient using a least square estimation scheme.

9. A method of encoding a video signal, the method comprising:
verifying a template and estimating a motion of the template using an input image to be encoded and a reference image to generate motion estimation information, when the input image is received;
generating a predicted image using the motion estimation information and the reference image;
calculating a filter coefficient with respect to the predicted image using the template;
filtering the predicted image using the filter coefficient;
calculating a difference between the input image and the filtered predicted image to generate a differential image;
performing integer-transformation and quantization for the differential image; and
entropy encoding the quantized differential image to output an image stream.

10. The method of claim 9, further comprising:
generating a reference image for a subsequent motion compensation by adding the differential image and the input image, to store the generated reference image.

11. The method of claim 9, wherein the template is a macro block that is located in any one of an upper side, a left side, an upper-left side, and an upper-right side of a current macro block.

12. The method of claim 9, wherein the filter coefficient is calculated using a least square estimation scheme.

13. A method of decoding a video signal, the method comprising:
entropy decoding an input image stream, when the input image stream is received;
performing inverse-quantization and inverse-transformation for the decoded input image stream to recover a differential image;
de-blocking filtering an image where a predicted image and the differential image are added, to generate an output image;
storing the output image as a reference image;
verifying a template and estimating a motion of the template using recent reference images to generate motion estimation information;
generating a subsequent predicted image using the motion estimation information and the reference image;
calculating a filter coefficient with respect to the subsequent predicted image using the template; and
filtering the subsequent predicted image using the filter coefficient.

14. The method of claim 13, wherein the template is a macro block that is located in any one of an upper side, a left side, an upper-left side, and an upper-right side of a current macro block.

15. The method of claim 13, wherein the filter coefficient is calculated using a least square estimation scheme.
